(19) United States
(12) Patent Application Publication
(10) Pub. No.: US 2004/0104545 A1
(43) Pub. Date: Jun. 3, 2004

(54) Connection of tool with tool bit

(76) Inventor: Tsai-Ching Chen, Chang Hua Hsien (TW)

Correspondence Address: CHARLES E. BAXLEY, ESQUIRE, Hart, Baxley, Daniels & Holton, 5 Fl., 59 John St., New York, NY, 10038, US

(21) Appl. No.: 10/308,369

(22) Filed: Dec. 2, 2002

(51) Int. Cl. B23B 31/107

(52) U.S. Cl. 279/81

(57) ABSTRACT

Here is disclosed a connector for connecting a tool with a tool bit including a polygonal portion formed thereon and an annular groove defined therein. The connector includes a socket, a detent, a sleeve and a positioning device. The socket includes a polygonal hole axially extending in an end thereof, a space in communication with the polygonal hole and an aperture extending through the socket in a radial direction. The detent is received in the aperture. The sleeve includes a recess defined in an internal face. The sleeve is rotationally mounted on the socket between an unlocking position and a locking position. In the unlocking position, the recess is aligned with the aperture so as to receive a portion of the detent in order to allow complete removal of the detent from the space, thus allowing insertion of the polygonal portion into the polygonal hole. In the locking position, the recess is not aligned with the aperture so as not to allow complete removal of the detent from the space so that the detent is partially received in the annular groove defined in the tool bit. The positioning device retains the sleeve in the unlocking position or the locking position.

### BACKGROUND OF INVENTION

1. Field of Invention

The present invention relates to connection of a tool with a tool bit and, more particularly, to a connector.

2. Related Prior Art

U.S. Pat. No. 5,470,180 discloses a reversible drill/driver tool. This conventional tool includes a socket 12 for receiving a tool assembly 18 and a shank 14 secured to the socket 12. The tool assembly 18 includes a body 26, a drill 20 secured to an end of the body 26, a screw driver 22 secured to an opposite end of the body 26, a polygonal portion 32 formed thereon and a groove 34 cut in the polygonal portion 32. The socket 12 includes a polygonal hole 16 defined therein for receiving the polygonal portion 32, a groove 40 extending in an external face thereof for receiving a retaining ring 44 and a hole 42 defined therein for receiving a detent ball 36 for releasable partial insertion in the groove 34. A sleeve 38 is mounted on the socket 12. The sleeve 38 includes grooves 46, 48 and 50 extending in an internal face thereof. When the retaining ring 44 is partially inserted in the groove 46, the groove 50 is aligned with hole 42. The detent ball 36 is allowed partial insertion in the groove 50. That is, the detent ball 36 can be completely removed from the groove 34. Thus, the polygonal portion 32 can be inserted in the polygonal hole 16. The sleeve 38 can be moved on the socket 12. When the retaining ring 44 is partially inserted in the groove 48, the groove 50 is not aligned with the hole 42. That is, the detent ball 36 is retained partially in the groove 34. Thus, polygonal portion 32 is retained in the polygonal hole 16.

Taiwanese Patent Publication No. 479599 discloses a tool including a socket 31 for receiving a tool bit 10. The tool bit 10 includes a polygonal portion 11 and a groove 111 defined in the polygonal portion 11. The socket 31 includes a polygonal hole 311 defined therein for receiving the polygonal portion 11, a hole 313 defined therein for receiving a detent ball 34 and grooves 314 and 315 extending in an external face thereof. A first ring 36 is received in the groove 314. A spring 35 is mounted on the socket 31. A sleeve 32 is mounted on the socket 31. The sleeve 32 includes a shoulder 321 extending on an internal face thereof. The spring 35 is compressed between the first ring 36 and the shoulder 321. A second ring 36 is received in the groove 315 for retaining the sleeve 32 on the socket 31. The sleeve 32 can be moved on the socket 31, thus compressing the spring 35. When the shoulder 321 is moved from the hole 313, the detent ball 34 can be completely removed from the polygonal hole 311. Thus, the polygonal portion 11 can be inserted in the polygonal hole 311. Then, the sleeve 32 is released. Biased by the spring 36, the shoulder 321 pushes the detent ball 34 partially in the groove 111. Thus, the polygonal portion 11 is retained in the polygonal hole 311.

In these conventional tools, the sleeves are axially moved on the sockets between the locking position and the unlocking position. However, such axial movement is not convenient due to resistance exerted via the retaining ring or the spring.

The present invention is therefore intended to obviate or at least alleviate the problem encountered in prior art.

### SUMMARY OF INVENTION

According to the present invention, a connector is provided for connecting a tool with a tool bit including a polygonal portion formed thereon and an annular groove defined therein. The connector includes a socket, a detent, a sleeve and a positioning device. The socket includes a polygonal hole axially extending in an end thereof, a space in communication with the polygonal hole and an aperture extending through the socket in a radial direction. The detent is received in the aperture. The sleeve includes a recess defined in an internal face. The sleeve is rotationally mounted on the socket between an unlocking position and a locking position. In the unlocking position, the recess is aligned with the aperture so as to receive a portion of the detent in order to allow complete removal of the detent from the space, thus allowing insertion of the polygonal portion into the polygonal hole. In the locking position, the recess is not aligned with the aperture so as not to allow complete removal of the detent from the space so that the detent is partially received in the annular groove defined in the tool bit. The positioning device retains the sleeve in the unlocking position or the locking position.

Other objects, advantages, and novel features of the invention will become more apparent from the following detailed description when taken in conjunction with the attached drawings.

### BRIEF DESCRIPTION OF DRAWINGS

The present invention will be described through detailed illustration of the preferred embodiment referring to the drawings.

FIG. 1 is a perspective view of a tool bit connected with a connector according to the preferred embodiment of the present invention.

FIG. 2 is an exploded view of the connector shown in FIG. 1.

FIG. 3 is a cross-sectional view of the connector shown in FIG. 2.

FIG. 4 is a cross-sectional view of the connector shown in FIG. 2 in a position for receiving and unlocking the tool bit.

FIG. 5 is a cross-sectional view of the connector shown in FIG. 4.

FIG. 6 is a cross-sectional view of the connector shown in FIG. 2 in a position for locking the tool bit.

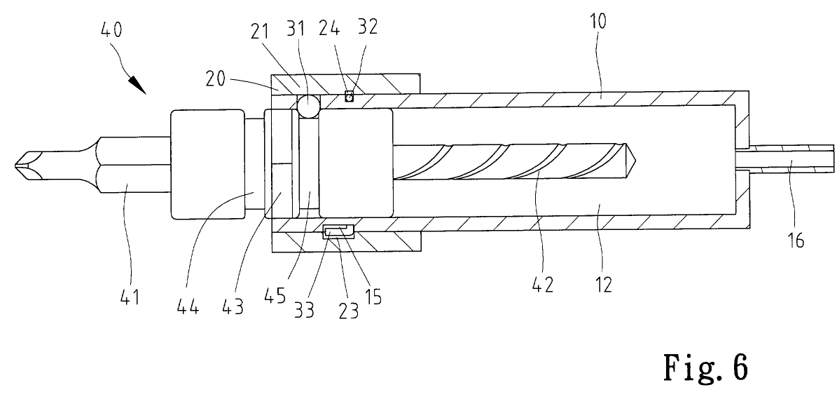

FIG. 7 is a cross-sectional view of the connector shown in FIG. 6.

### DETAILED DESCRIPTION OF PREFERRED EMBODIMENT

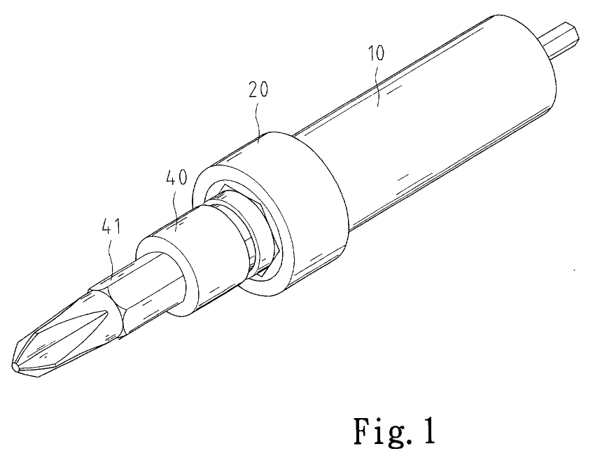

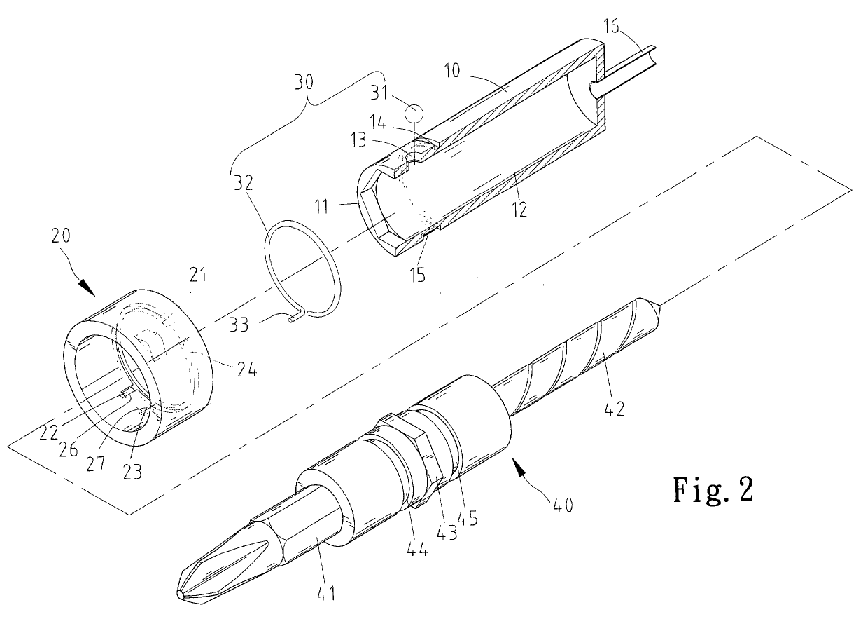

Referring to FIGS. 1-3, a connector according to the preferred embodiment of the present invention is used to connect a conventional tool bit 40 with a conventional tool (not shown) that can be manually or automatically driven.

The tool bit 40 includes a body (not numbered), a screwdriver 41 extending from an end of the body, a drill 42 extending from an opposite end of the body, a polygonal portion 43 formed on the body, a first annular groove 44 defined in the body near the screwdriver 41 and a second annular groove 45 defined in the body near the drill 42.

The connector includes a socket 10, a sleeve 20 mounted on the socket 10 and a positioning device 30 arranged between the socket 10 and the sleeve 20.

The socket 10 includes a polygonal hole 11 axially extending in an end thereof, a space 12 in communication with the polygonal hole 11, an shaft 16 extending from an opposite end thereof, an aperture 13 extending through the socket 10 in a radial direction, an annular groove 14 extending in an external face thereof and a longitudinal groove 15 extending from the annular groove 14.

The positioning device 30 includes a detent ball 31 received in the aperture 13, a ring 32 received in the annular ring 14 and a latch 33 integrated with the ring 32 and received in the longitudinal groove 15.

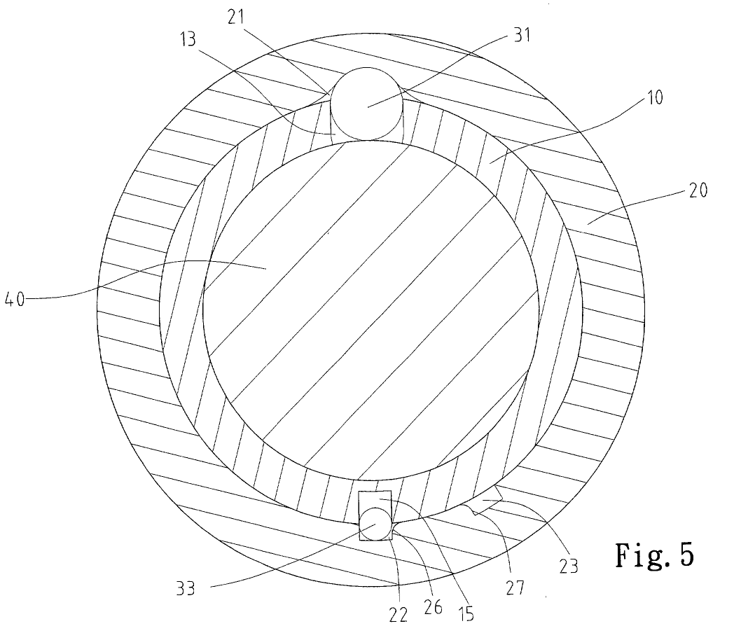

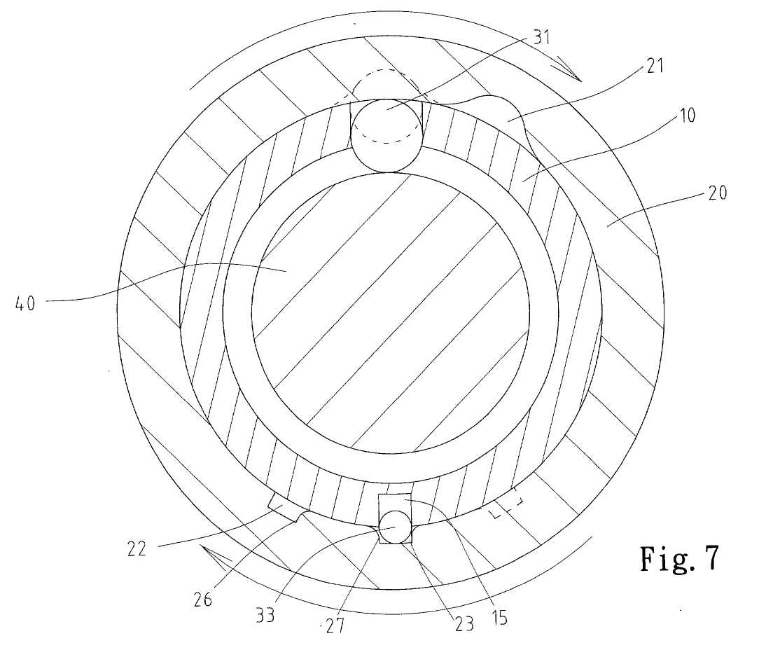

The sleeve 20 includes an internal face. A recess 21, two longitudinal grooves 22 and 23 and an annular groove 24 are defined in the internal face of the sleeve 20. Each of the longitudinal grooves 22 and 23 is in communication with the annular groove 24. Each of the longitudinal grooves 22 and 23 is defined between two sidewalls. Referring to FIGS. 5 and 7, one of the sidewalls of the longitudinal groove 22 close to the longitudinal groove 23 is formed as an inclined face 26, and one of the sidewalls of the longitudinal groove 23 close to the longitudinal groove 22 is formed as an inclined face 27.

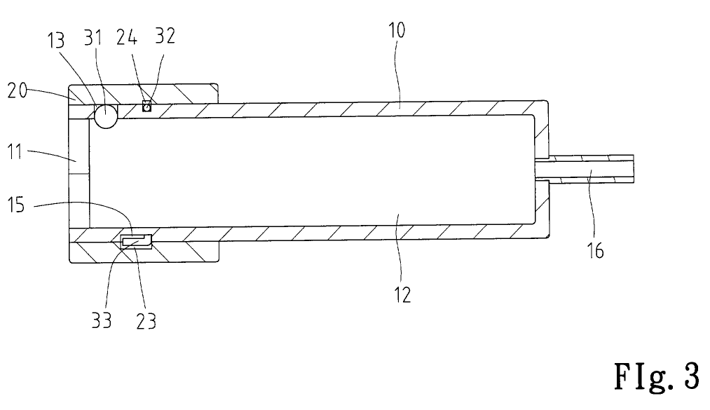

The sleeve 20 is rotationally mounted on the socket 10 and around the positioning device 30. In FIG. 3, the ring 32 is received in the annular groove 24, and the latch 33 is received in the longitudinal groove 23. The recess 21 is not aligned with the aperture 13.

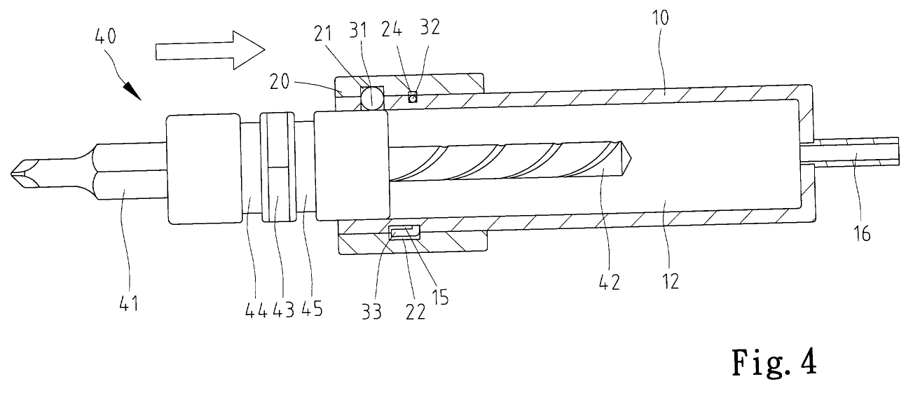

The sleeve 20 can be rotated on the socket 10 from the position shown in FIG. 3 to a position shown in FIGS. 4 and 5. The longitudinal groove 22 is aligned with the longitudinal groove 15 so as to receive the latch 33. The recess 21 is aligned with the aperture 13. The detent ball 31 can be completely removed from the space 12 so as to allow insertion of the body of the tool bit 40 into the space 12 and therefore insertion of the polygonal portion 43 into the polygonal hole 11.

The sleeve 20 can be rotated on the socket 10 from the position shown in FIGS. 4 and 5 to the position shown in FIGS. 3, 4 and 5. The longitudinal groove 23 is aligned with the longitudinal groove 15 so as to receive the latch 33. The recess 21 is not aligned with the aperture 13. The detent ball 31 cannot be completely removed from the space 12. That is, the detent ball 31 is partially received in the annular groove 45 or 44. Thus, the tool bit 40 is locked to the socket 10.

The present invention has been described via illustration of the preferred embodiment. The applicant gives this embodiment only as an example, and those skilled in the art can derive variations from this embodiment after a study of this specification. Hence, this embodiment shall not limit the scope of the present invention that is defined in the following claims.

What is claimed is:

1. A connector for connecting a tool with a tool bit including a polygonal portion and an annular groove, the connector including:
a socket includes a polygonal hole axially extending in an end thereof, a space in communication with the polygonal hole and an aperture extending through the socket in a radial direction;
a detent received in the aperture;
a sleeve including an internal face and a recess defined in the internal face, wherein the sleeve is rotationally mounted on the socket between an unlocking position where the recess is aligned with the aperture so as to receive a portion of the detent in order to allow complete removal of the detent from the space, thus allowing insertion of the polygonal portion into the polygonal hole and a locking position where the recess is not aligned with the aperture so as not to allow complete removal of the detent from the space so that the detent is partially received in the annular groove defined in the tool bit; and
a positioning device for selectively retaining the sleeve in one of the unlocking position and the locking position.

2. The connector according to claim 1 wherein the sleeve includes a first groove defined therein and a second groove defined therein, and the positioning device includes a latch connected with the socket for insertion in the first groove in the unlocking position and insertion in the second groove in the locking position.

3. The connector according to claim 2 wherein the first and second grooves are defined in the internal face of the sleeve.

4. The connector according to claim 3 wherein the socket includes a groove defined in the external face thereof for receiving the latch.

5. The connector according to claim 1 wherein the socket includes an external face, an annular groove extending in the external face and a longitudinal groove extending from the annular groove, the sleeve includes a first longitudinal groove defined in the internal face, a second longitudinal groove defined in the internal face and an annular groove defined in the internal face and communicated with the first and second longitudinal grooves, and the positioning device includes a ring received in the annular grooves and a latch integrated with the ring and received in the longitudinal groove of the socket for insertion in the first longitudinal groove of the sleeve in the unlocking position and insertion in the second longitudinal groove of the sleeve in the locking position.

6. The connector according to claim 1 wherein each of the first and second longitudinal grooves is defined between two sidewalls, and one of the sidewalls of the first longitudinal groove close to the second longitudinal groove is formed as an inclined face.

7. The connector according to claim 1 wherein each of the first and second longitudinal grooves is defined between two sidewalls, and one of the sidewalls of the second longitudinal groove close to the first longitudinal groove is formed as an inclined face.

8. The connector according to claim 1 wherein the detent is a ball.

9. The connector according to claim 1 wherein the socket further includes a shaft extending from an opposite end thereof.
